(19) United States
(12) Patent Application Publication
(10) Pub. No.: US 2026/0252925 A1
(43) Pub. Date: Aug. 27, 2026

(54) SYSTEM AND METHOD FOR ENTERPRISE APPLICATION DECISION CAPTURE AND LEARNING

(71) Applicant: ORACLE INTERNATIONAL CORPORATION, Redwood Shores, CA (US)

(72) Inventors: Joseph Fitts, San Mateo, CA (US); James Richardson, Manchester (GB)

(21) Appl. No.: 19/179,732

(22) Filed: Apr. 15, 2025

Related U.S. Application Data
(60) Provisional application No. 63/763,105, filed on Feb. 25, 2025.

(51) Int. Cl. G06N 5/045; G06Q 10/0631

(52) U.S. Cl. CPC G06N 5/045; G06Q 10/06315

(57) ABSTRACT

Embodiments described herein are generally related to data analytics environments, and are particularly directed to a system and method for enterprise application decision capture and learning. The described approach can be used to capture information about decisions made within an organization, and provide feedback to machine learning or other processes, for use in forming an understanding of the decisions, or generating recommendations for future actions. Decision objects can be used to capture and store decision records in a decision store, which indicates the fact that a decision has been made, together with a decision context. The decision store can include information descriptive of decisions made within various analytic applications, such as for example, ERP, HCM, HR, or SCM applications, or within a larger enterprise ecosystem, to provide a bottom-up approach in learning from the decisions and actions that users take within the organization.

### CLAIM OF PRIORITY AND CROSS-REFERENCE TO RELATED APPLICATIONS

This application claims the benefit of priority to U.S. Provisional Patent Application titled “SYSTEM AND METHOD FOR ENTERPRISE APPLICATION DECISION CAPTURE AND LEARNING”, Application No. 63/763,105, filed Feb. 25, 2025; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to a system and method for enterprise application decision capture and learning.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

Business users may be interested in learning from previous decision-making and applying that knowledge to future projects. However, present systems typically do not capture data that would be useful in helping organizations to learn from the decisions people make.

### SUMMARY

Embodiments described herein are generally related to data analytics environments, and are particularly directed to a system and method for enterprise application decision capture and learning.

The described approach can be used to capture information about decisions made within an organization, and provide feedback to machine learning or other processes, for use in forming an understanding of the decisions, or generating recommendations for future actions.

Decision objects can be used to capture and store decision records in a decision store, which indicates the fact that a decision has been made, together with a decision context. The decision store can include information descriptive of decisions made within various analytic applications, such as for example, ERP, HCM, HR, or SCM applications, or within a larger enterprise ecosystem, to provide a bottom-up approach in learning from the decisions and actions that users take within the organization.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 illustrates a system that provides a decision capture and learning environment, in accordance with an embodiment.

FIG. 10 further illustrates a system that provides a decision capture and learning environment, in accordance with an embodiment.

FIG. 11 further illustrates a system that provides a decision capture and learning environment, in accordance with an embodiment.

FIG. 12 further illustrates a system that provides a decision capture and learning environment, in accordance with an embodiment.

FIG. 13 illustrates a decision capture and learning process, in accordance with an embodiment.

FIG. 14 illustrates an example use of a decision capture and learning environment or process, in accordance with an embodiment.

FIG. 15 further illustrates an example use of a decision capture and learning environment or process, in accordance with an embodiment.

FIG. 16 further illustrates an example use of a decision capture and learning environment or process, in accordance with an embodiment.

FIG. 17 further illustrates an example use of a decision capture and learning environment or process, in accordance with an embodiment.

FIG. 18 further illustrates an example use of a decision capture and learning environment or process, in accordance with an embodiment.

FIG. 19 further illustrates an example use of a decision capture and learning environment or process, in accordance with an embodiment.

FIG. 20 further illustrates an example use of a decision capture and learning environment or process, in accordance with an embodiment.

FIG. 21 further illustrates an example use of a decision capture and learning environment or process, in accordance with an embodiment.

FIG. 22 further illustrates an example use of a decision capture and learning environment or process, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Analytics Cloud (OAC), and Fusion Analytics Warehouse (FAW), which support features such as data mining or analytics, and analytic applications.

Business users may be interested in learning from previous decision-making and applying that knowledge to future projects. However, present systems typically do not capture data that would be useful in helping organizations to learn from the decisions people make.

Embodiments described herein are generally related to data analytics environments, and are particularly directed to a system and method for enterprise application decision capture and learning.

The described approach can be used to capture information about decisions made within an organization, and provide feedback to machine learning or other processes, for use in forming an understanding of the decisions, or generating recommendations for future actions. Decision objects can be used to capture and store decision records in a decision store, which indicates the fact that a decision has been made, together with a decision context. The decision store can include information descriptive of decisions made within various analytic applications, such as for example, ERP, HCM, HR, or SCM applications, or within a larger enterprise ecosystem, to provide a bottom-up approach in learning from the decisions and actions that users take within the organization.

In accordance with an embodiment, technical advantages of the systems and methods described herein include, for example, that decision objects can be used to capture and store decision records in a decision store, which indicates the fact that a decision has been made, together with a decision context. The decision store can include information descriptive of decisions made within various analytic applications, such as for example, ERP, HCM, HR, or SCM applications, or within a larger enterprise ecosystem, to provide a bottom-up approach in learning from the decisions and actions that users take within the organization. Decision data stored in the decision store can be used as a training dataset for AI environments, machine learning, or other automated components to learn about human decision-making. The decision data can be analyzed and used within the system, or fed back to people, helping to make better, faster decisions.

### Cloud Infrastructure Environments

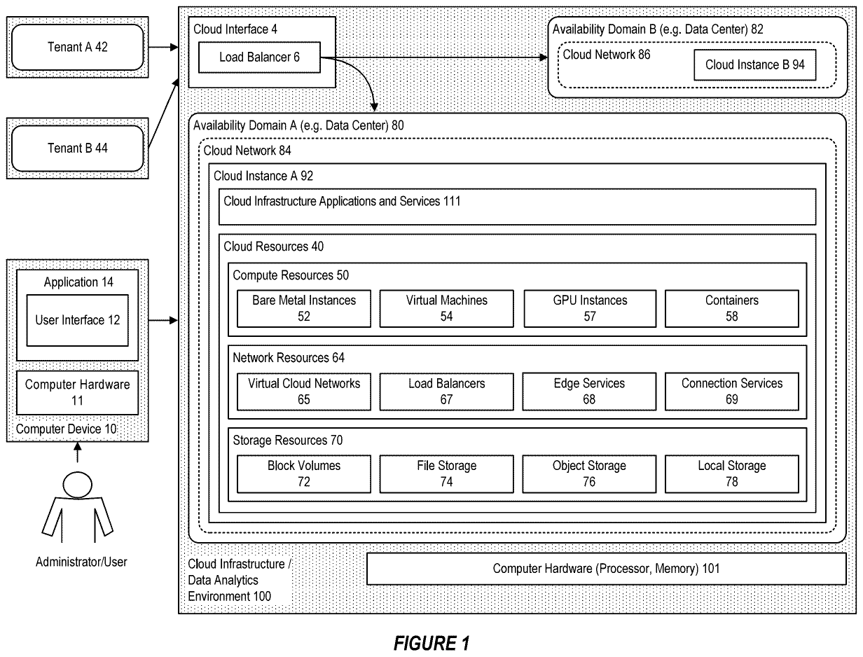

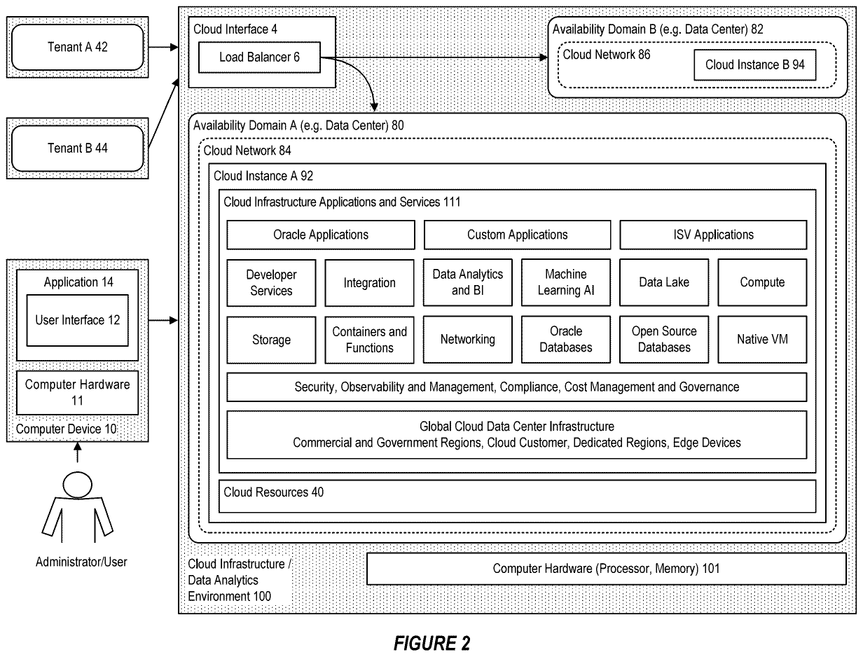

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

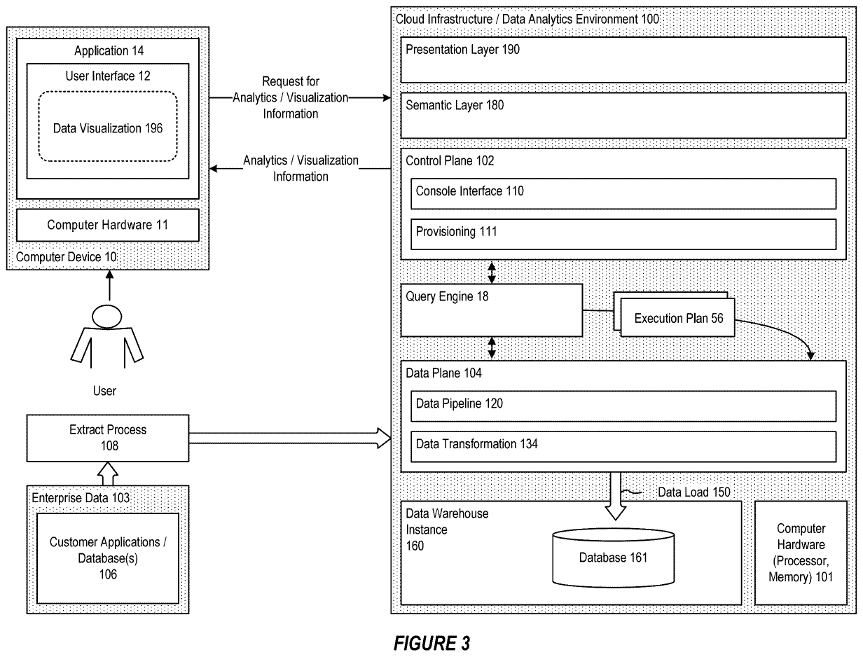

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Analytics Cloud server instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

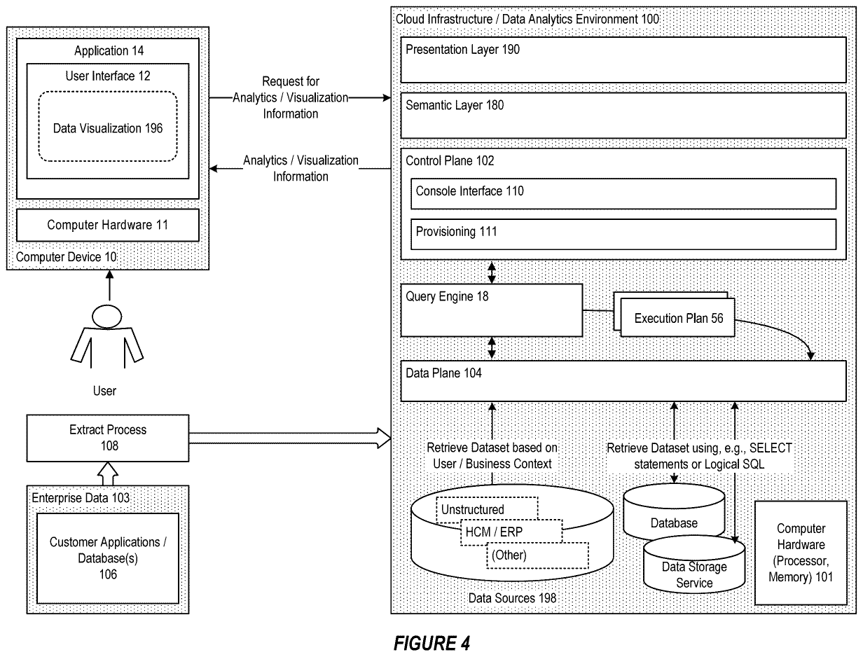

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), Human Resources (HR), Supply Chain Management (SCM), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

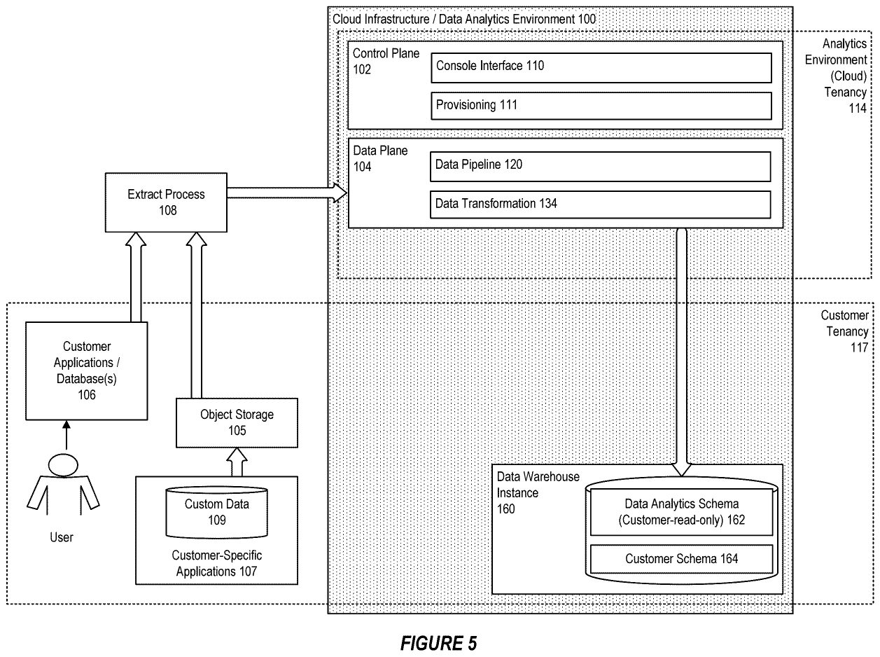

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

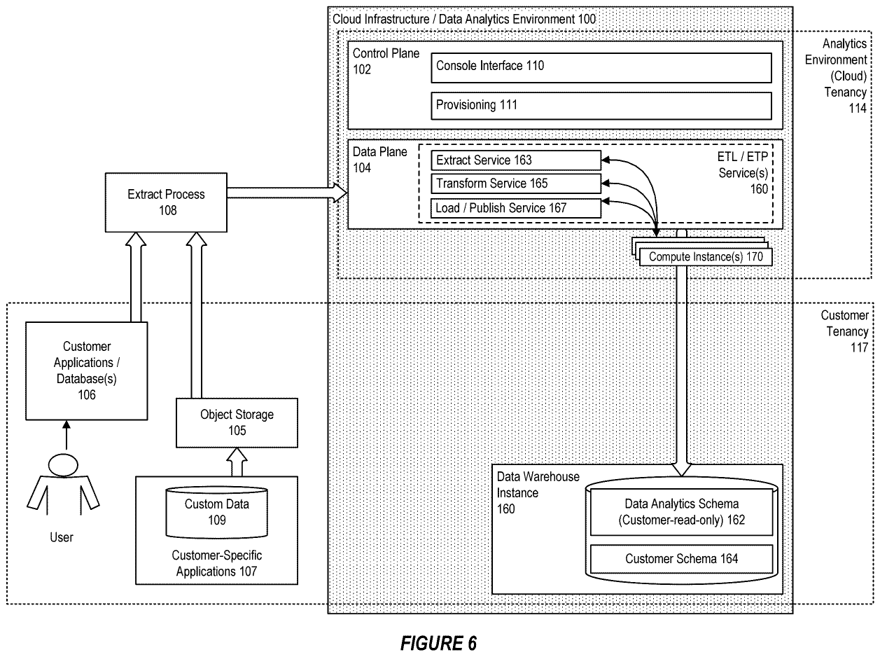

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

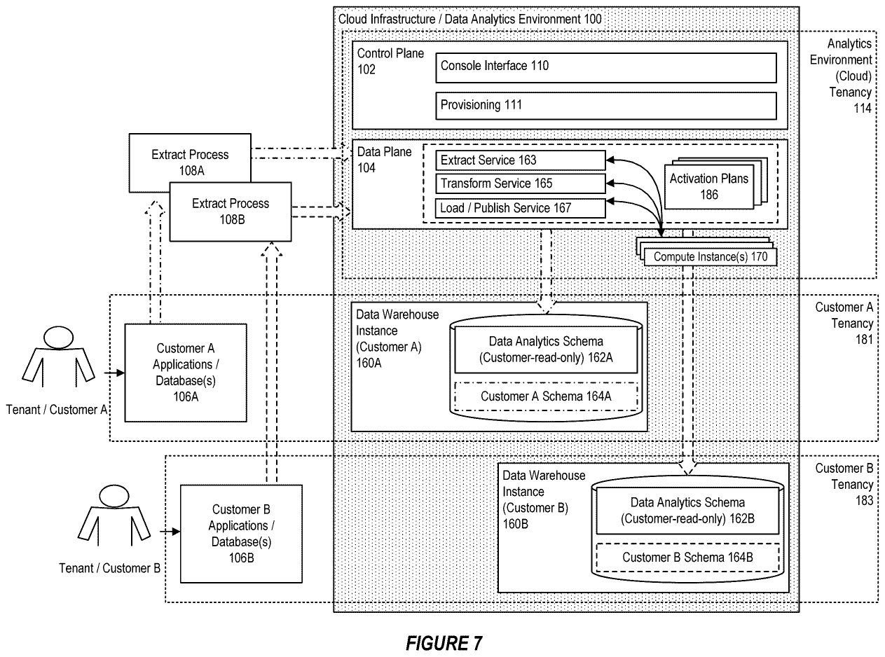

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

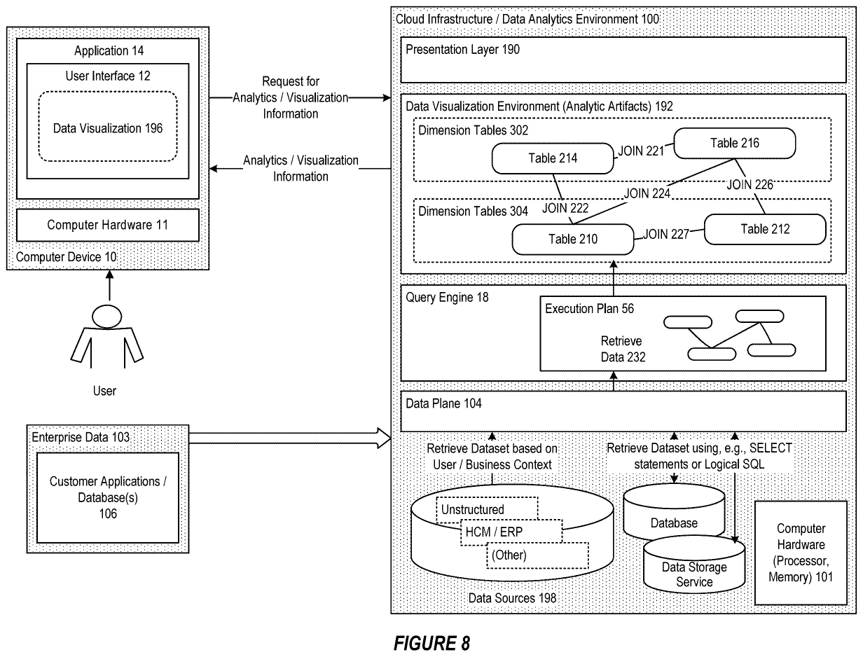

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Enterprise Application Decision Capture and Learning

Business users may be interested in learning from previous decision-making and applying that knowledge to future projects. However, present systems typically do not capture data that would be useful in helping organizations to learn from the decisions people make.

For example, an intelligent enterprise application may be programmed to generate a recommendation based on one or more mathematical or analytical statistical techniques, such as assessing various amounts and determining which action is likely to have an effect on those numbers. Such applications are useful in allowing a user to collaborate with another person as to what decision to make. However, they generally do not take into account past decisions, or why those decision were made.

In accordance with an embodiment, described herein is a system and method for enterprise application decision capture and learning. The described approach can be used to capture information about decisions made within an organization, and provide feedback to machine learning or other processes, for use in forming an understanding of the decisions, or generating recommendations for future actions. Decision objects can be used to capture and store decision records in a decision store, which indicates the fact that a decision has been made, together with a decision context. The decision store can include information descriptive of decisions made within various analytic applications, such as for example, ERP, HCM, HR, or SCM applications, or within a larger enterprise ecosystem, to provide a bottom-up approach in learning from the decisions and actions that users take within the organization.

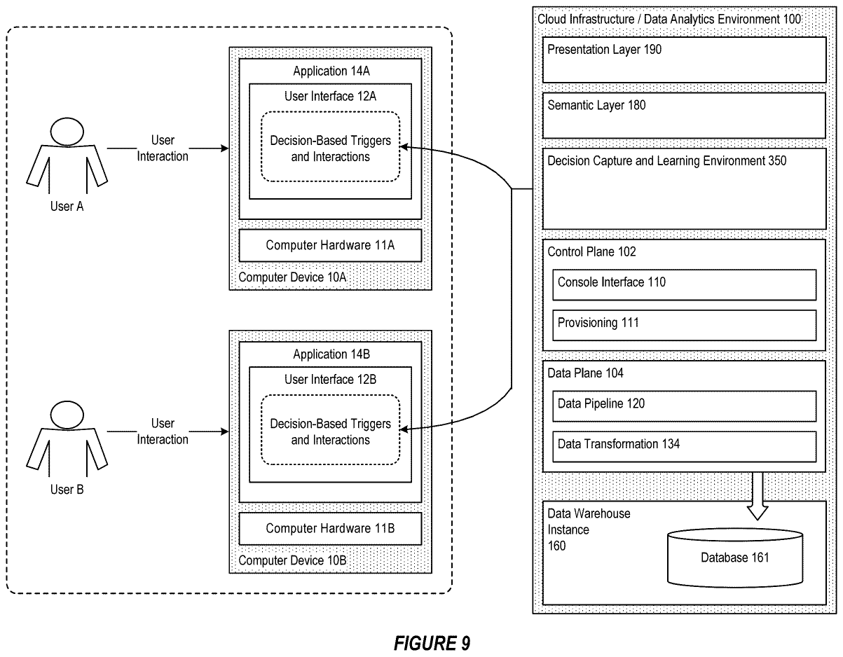

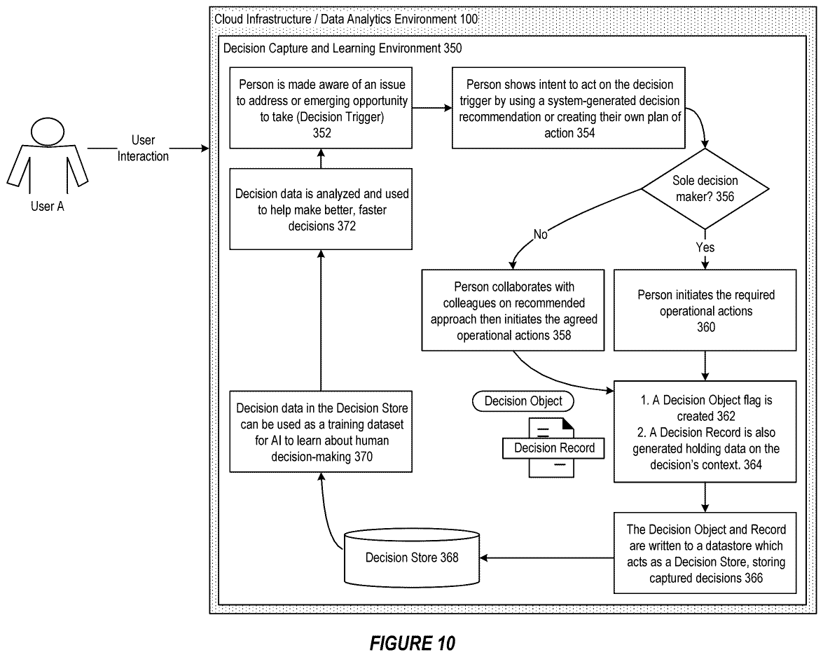

FIGS. 9-10 illustrate a system that provides a decision capture and learning environment, in accordance with an embodiment.

In accordance with an embodiment, the system operates to record a decision that is made or taken, and the actions or context related to that decision. The system can then assess whether past decisions were useful in addressing a particular scenario or solving a particular problem. Such decisions, actions, and outcomes can be tracked over time, allowing the system to generate detailed recommendations or “decision learnings”—for example, to provide an indication or advice that in the past a particular person performed a particular action to address a similar scenario, together with the outcome. Decision learnings, recommendations, or other information can be surfaced to a user interface (UI), and adjusted or modified to prepare plans, which when enacted can generate or update a corresponding workflow within the system, such as for example, a HR or SCM data flow.

As illustrated in FIGS. 9-10, in accordance with an embodiment, a decision capture and learning environment 350 allows users to interact with the system in association with decision-based triggers and interactions.

In accordance with an embodiment, a person (e.g., a HR professional) is made aware of an issue to address or emerging opportunity to take (i.e., a decision trigger, 352). Persons may be associated with roles, such as for example, a HR or SCM role. In some instances, the person may decide to do nothing, in which case no decision is recorded. The person can show an intent to act on the decision trigger by using a system-generated decision recommendation or creating their own plan of action (354).

In accordance with an embodiment, if the person shows intent to act on the trigger by exploring options, then they can make a decision either independently or by collaboration with other people. If the person is the sole decision maker (356), they can initiate the required operational actions (360). Otherwise, the person collaborates with colleagues on recommended approach and then initiates the agreed operational actions (358).

In accordance with an embodiment, a decision object flag (362), and decision record (364) are generated to hold data on the decision's context. In some implementations, the decision object and decision record can be provided by a combined component, with the decision object operating as a key into the decision record. An example of a decision record is illustrated in Table 1 below. In accordance with other embodiments, other types of decision objects or decision records can be used.

TABLE 1
Example Decision Record

| | |
|---|---|
| Who | User ID |
| When | Time stamp |
| Trigger (Decision | Alert conditions, modelled risks |
| Intention) | |
| Thresholds | Preset goals or decision criteria |
| Recommendations Made | Prescribed actions shown to user |
| Recommendations | Prescribed actions opened by user |
| Viewed | |
| Recommendation | Prescribed actions selected for action |
| Selected | |
| Decision Collaborators | Other people consulted during an action |
| | approval |
| Operations Suggested | Prescribed operational steps shown to user |
| Operations Initiated | Prescribed operational steps selected for |
| | action |
| Operation Completion | Time stamp showing when operational step |
| | completed |
| Decision Fulfilment | Time stamp of when all operational steps are |
| | completed |
| Decision Outcome vs. | Actual versus expected outcome on the initial |
| Recommendation | decision trigger |

In accordance with an embodiment, the decision object and decision record are written to a datastore which acts as a decision store, storing captured decisions (366). Decision data stored in the decision store (368) can be used as a training dataset for AI environments, machine learning, or other automated components to learn about human decision-making (370). The decision data can be analyzed and used within the system, or fed back to people, helping to make better, faster decisions (372).

In accordance with an embodiment, as decisions are made the decision store is populated with a collective knowledge of decision-making within the enterprise, providing a record of decisions made by a community of potentially many (e.g., hundreds of) decision-makers.

In accordance with an embodiment, the system and decision store can be initially trained by implementing a decision capture mechanism as described above, and allowing it to operate for a period of time (e.g., several weeks), to populate the decision store. In accordance with an embodiment, the system can capture the shape of a particular decision-making process and user decisions from a first entity, for use with a second entity, such as for example between a first department and a second department within an enterprise, to reflect best practices by those decision makers.

In accordance with an embodiment, the decision store can include granular detail that allows a user to examine the steps made in association with a particular decision and any steps resulting from that decision.

In accordance with an embodiment, decision learnings, recommendations, plans, or other information surfaced to a user interface can be updated dynamically based on decisions that have been made in the interim. For example, the decision store can record best outcomes from previous decisions, and then determine which persons appear to have made decisions with the best outcomes (i.e., the best decisions), and then rank those decisions accordingly.

In accordance with an embodiment, since the outcome of a particular decision may not be identifiable for some time after the decision has been made, a decision record can include timestamps to reflect that some decision are tactical, rather than strategic, in nature—with short feedback loops. This allows the system to assess decisions that should have an effect within their associated threshold. When such a decision is made, the system can wait for a duration of the threshold, before considering the decision completed such that the decision and its actions or outcomes can be taken into account.

In accordance with an embodiment, the decision learnings, recommendations, and other information can be surfaced in a variety of environments, including for example as dashboards or user interfaces provided to a decision engineer whose role within the enterprise organization is to optimize the decision-making process.

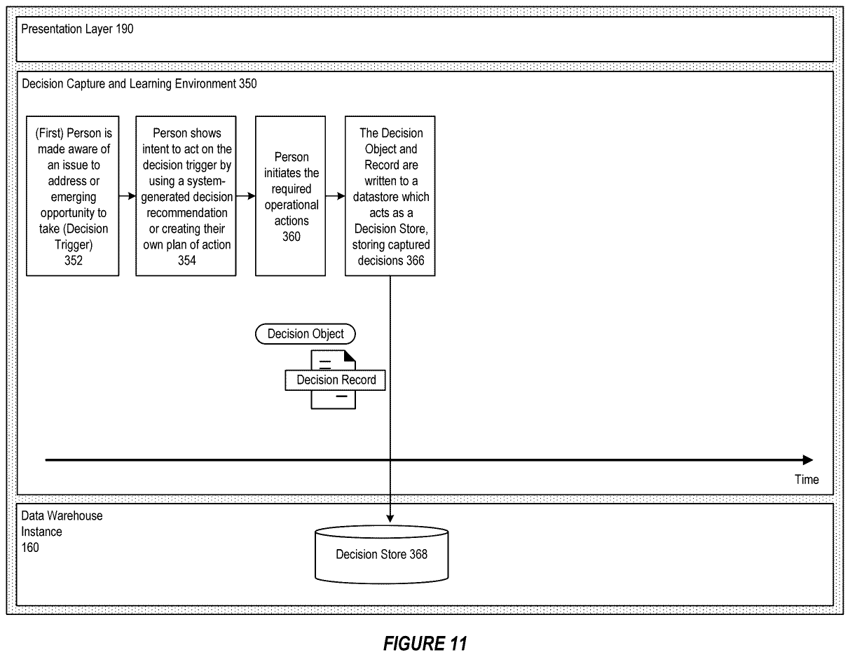

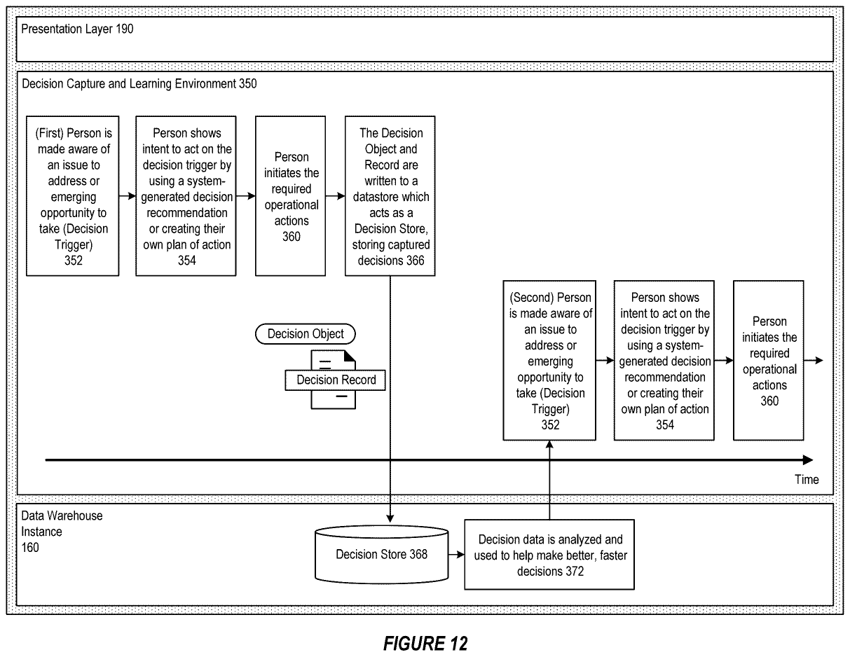

FIGS. 11-12 further illustrate a system that provides a decision capture and learning environment, in accordance with an embodiment.

As illustrated in FIGS. 11-12, in accordance with an embodiment, the decision objects can be used to capture and store decision records in a decision store, which indicates the fact that a decision has been made, together with a decision context. Decision data stored in the decision store can be used as a training dataset for AI environments, machine learning, or other automated components to learn about human decision-making. The decision data can be analyzed and used within the system, or fed back to people, helping to make better, faster decisions.

For example, in accordance with an embodiment, a first person (e.g., a HR professional) can be made aware of an issue to address or emerging opportunity to take (i.e., a decision trigger); and initiate actions that result in a decision record being stored in the decision store. Subsequently, a second person (e.g., another HR professional) being made aware of a similar issue can be guided by the system using the previously-stored and analyzed decision data.

### Decision Capture and Learning Process

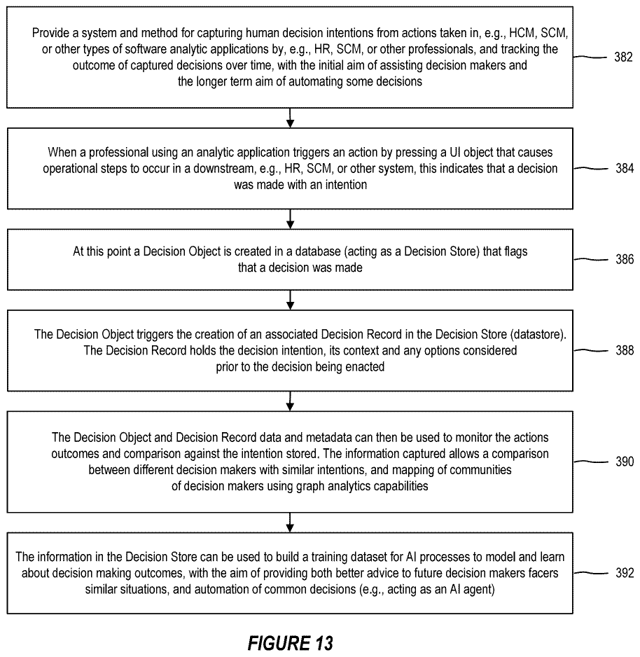

FIG. 13 illustrates a decision capture and learning process, in accordance with an embodiment.

As illustrated in FIG. 13, in accordance with an embodiment, the decision capture and learning process can include, at 382, providing a system and method for capturing human decision intentions from actions taken in, e.g., HCM, SCM, or other types of software analytic applications by, e.g., HR, SCM, or other professionals, and tracking the outcome of captured decisions over time, with the initial aim of assisting decision makers and the longer term aim of automating some decisions.

At 384, when a professional using an, e.g., Oracle Fusion Data Intelligence (FDI), HCM, ERP, or other analytic application triggers an action by pressing a UI object that causes operational steps to occur in a downstream, e.g., HR, SCM, or other system, this indicates that a decision was made with an intention.

At 386, at this point a decision object is created in a database (acting as a decision store) that flags that a decision was made.

At 388, in turn, the decision object triggers the creation of an associated decision record in the decision store (datastore). The decision record holds the decision intention, its context and any options considered prior to the decision being enacted.

At 390, the decision object and decision record data and metadata can then be used to monitor the actions outcomes and comparison against the intention stored. The information captured allows a comparison between different decision makers with similar intentions, and mapping of communities of decision makers using graph analytics capabilities.

At 392, the information in the decision store can be used to build a training dataset for AI processes to model and learn about decision making outcomes, with the aim of providing both better advice to future decision makers facers similar situations, and automation of common decisions (e.g., acting as an AI agent).

### Decision Capture and Learning Example

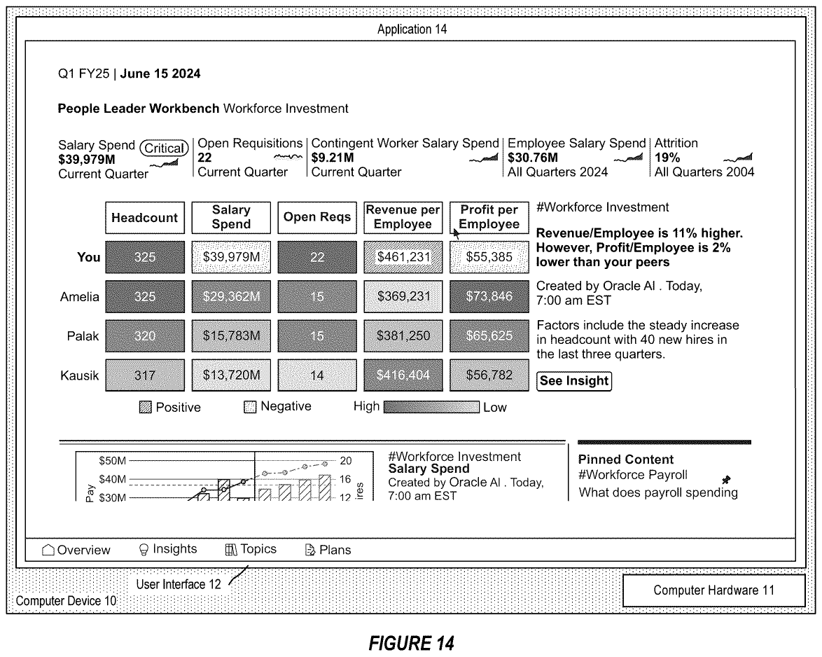

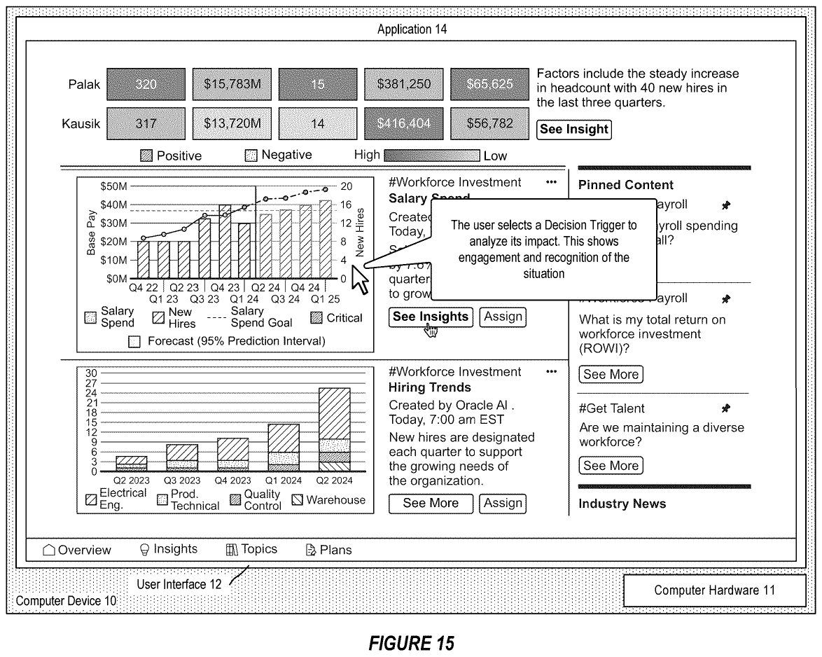

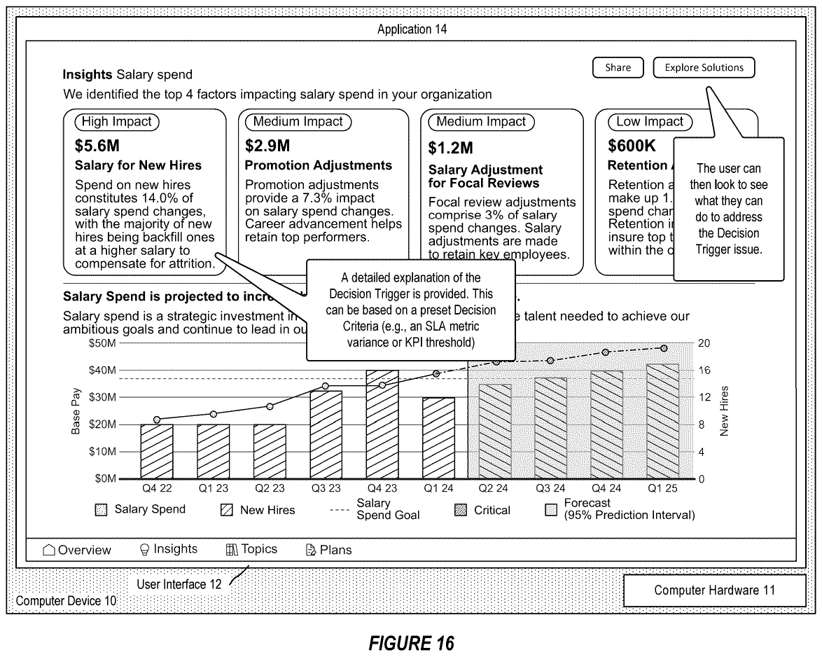

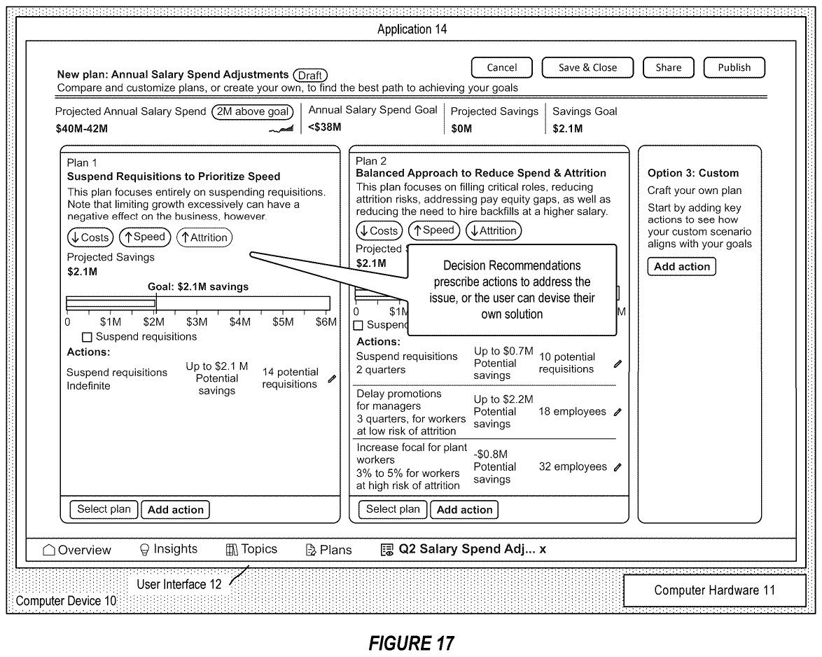

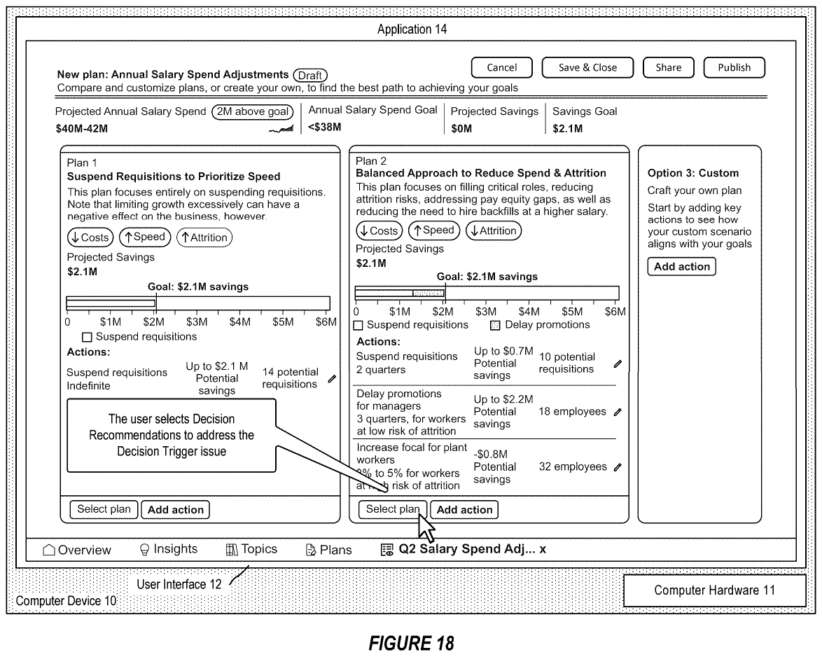

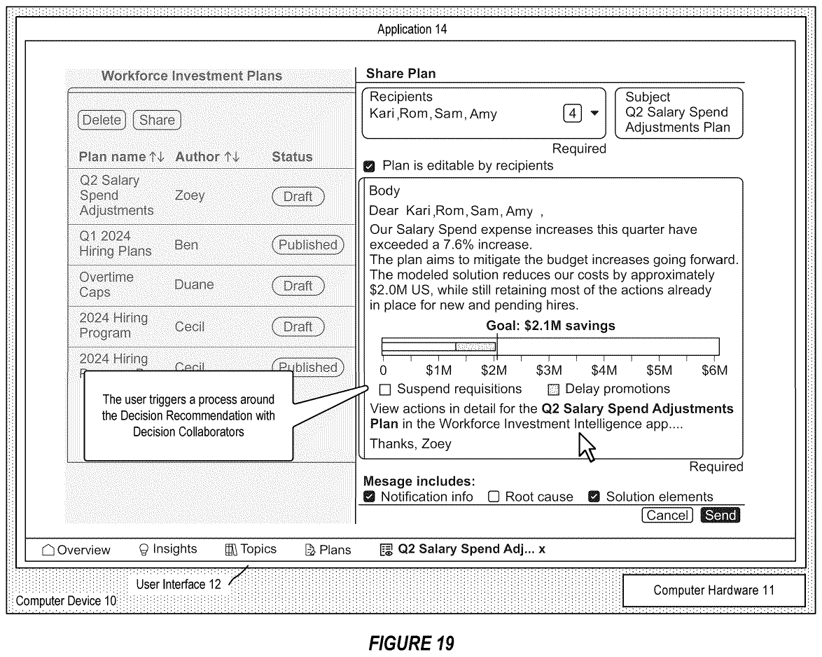

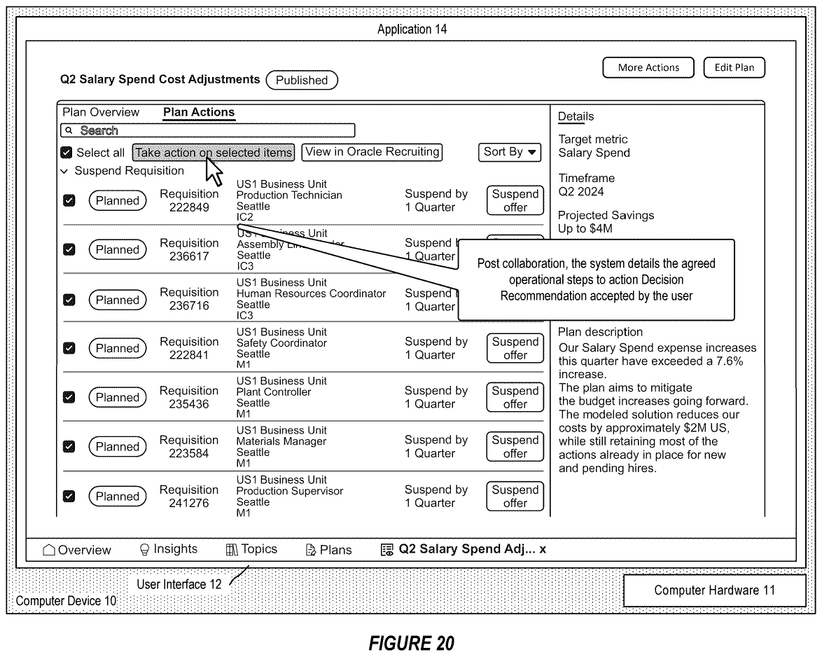

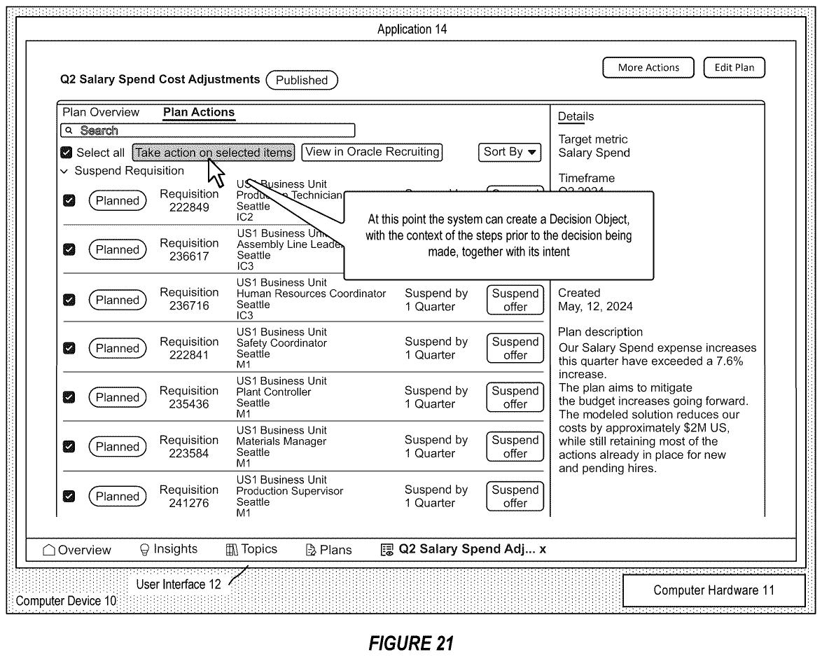

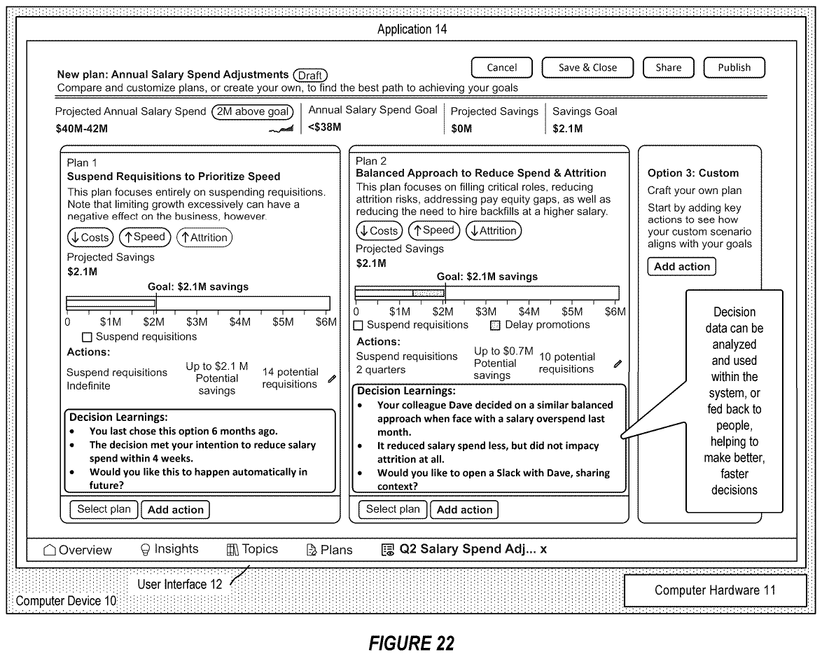

FIGS. 14-22 illustrate an example use of a decision capture and learning environment or process, in accordance with an embodiment.

Without the use of a decision object capture process:

The analytic application delivers an alert, e.g., by means of a KPI drawing attention to the fact that salary spend is too high.

A HR professional aims to better understand the situation by interacting with data visualizations on a dashboard.

The analytic application offers a choice of actions to address the overspend.

The user selects a set of actions after collaborating with other, e.g., HR, stakeholders.

Actions are triggered in, e.g., an operational HCM system, to solve the overspend issues.

Using the above approach, the user generally has no further view of whether the actions taken were effective. However, as illustrated in FIG. 14-22, in accordance with an embodiment, when a decision object capture process is used to assess the above scenario:

The analytic application delivers an alert, e.g., by means of a KPI drawing attention to the fact that salary spend is too high.

A HR professional aims to better understand the situation by interacting with data visualizations on a dashboard.

The analytic application offers a choice of actions to address the overspend.

The analytic application uses captured decisions to provide information about prior decisions relating to this KPI by other, e.g., HR, stakeholders.

The analytic application makes ML-derived decision recommendations based on patterns in decision objects.

The user selects a set of actions after collaborating with other, e.g., HR, stakeholders.

Actions are triggered in, e.g., an operational HCM system, to solve the overspend issues.

The decision to take these actions is logged, and the HR professional can review its impact over time.

As described above, in accordance with an embodiment, the decision data stored in the decision store can be used as a training dataset for AI environments, machine learning, or other automated components to learn about human decision-making. The decision data can be analyzed and used within the system, or fed back to people, helping to make better, faster decisions.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for providing decision capture and learning, comprising:
a computer including one or more processors, that provides access to a data analytics environment; and
wherein the system operates to capture and store decision records in a decision store, which indicates the fact that a decision has been made, together with a decision context, which decision-related information is used within the system or to provide feedback to machine learning or other processes, for use in forming an understanding of the decisions, or generating recommendations for future actions.

2. The system of claim 1, wherein the system and decision store are initially trained by implementing a decision capture mechanism and allowing it to operate for a period of time to populate the decision store and capture the shape of a particular decision-making process.

3. The system of claim 1, wherein each decision record includes timestamps that enable the system to assess decisions that should have an effect within an associated threshold.

4. The system of claim 1, wherein the decision store is populated with a collective knowledge of decision-making within the enterprise, providing a record of decisions made by a community of decision-makers.

5. The system of claim 1, wherein decision learnings, recommendations, or other information can be surfaced to a user interface, and adjusted or modified to prepare plans, which when enacted can generate or update a corresponding workflow within the system.

6. The system of claim 1, wherein the system is provided within or as part of a cloud environment.

7. A method for providing decision capture and learning, comprising:
providing, by a computer system including one or more processors, access to a data analytics environment; and
capturing and storing decision records in a decision store, which indicates the fact that a decision has been made, together with a decision context, which decision-related information is used within the system or to provide feedback to machine learning or other processes, for use in forming an understanding of the decisions, or generating recommendations for future actions.

8. The method of claim 7, wherein the system and decision store are initially trained by implementing a decision capture mechanism and allowing it to operate for a period of time to populate the decision store and capture the shape of a particular decision-making process.

9. The method of claim 7, wherein each decision record includes timestamps that enable the system to assess decisions that should have an effect within an associated threshold.

10. The method of claim 7, wherein the decision store is populated with a collective knowledge of decision-making within the enterprise, providing a record of decisions made by a community of decision-makers.

11. The method of claim 7, wherein decision learnings, recommendations, or other information can be surfaced to a user interface, and adjusted or modified to prepare plans, which when enacted can generate or update a corresponding workflow within the system.

12. The method of claim 7, wherein the method is performed within or as part of a cloud environment.

13. A non-transitory computer readable storage medium, including instructions stored thereon which when read and executed by one or more computers cause the one or more computers to perform a method comprising:
providing, by a computer system including one or more processors, access to a data analytics environment; and
capturing and storing decision records in a decision store, which indicates the fact that a decision has been made, together with a decision context, which decision-related information is used within the system or to provide feedback to machine learning or other processes, for use in forming an understanding of the decisions, or generating recommendations for future actions.

14. The non-transitory computer readable storage medium of claim 13, wherein the system and decision store are initially trained by implementing a decision capture mechanism and allowing it to operate for a period of time to populate the decision store and capture the shape of a particular decision-making process.

15. The non-transitory computer readable storage medium of claim 13, wherein each decision record includes timestamps that enable the system to assess decisions that should have an effect within an associated threshold.

16. The non-transitory computer readable storage medium of claim 13, wherein the decision store is populated with a collective knowledge of decision-making within the enterprise, providing a record of decisions made by a community of decision-makers.

17. The non-transitory computer readable storage medium of claim 13, wherein decision learnings, recommendations, or other information can be surfaced to a user interface, and adjusted or modified to prepare plans, which when enacted can generate or update a corresponding workflow within the system.

18. The non-transitory computer readable storage medium of claim 13, wherein the method is performed within or as part of a cloud environment.
